(19) United States
(12) Patent Application Publication
(10) Pub. No.: US 2005/0168148 A1
(43) Pub. Date: Aug. 4, 2005

(54) Optical control of light in ceramic arctubes

(75) Inventors: Gary R. Allen, Chesterland, OH (US); Alan G. Chalmers, Akron, OH (US); David C. Dudik, South Euclid, OH (US); Viktor K. Varga, Solon, OH (US); Peter Brown, Twinsburg, OH (US)

Correspondence Address: PEARNE & GORDON LLP, 1801 EAST 9TH STREET, SUITE 1200, CLEVELAND, OH, 44114-3108, US

(73) Assignee: General Electric Company

(21) Appl. No.: 11/016,118

(22) Filed: Dec. 17, 2004

Related U.S. Application Data
(60) Provisional application No. 60/540,475, filed on Jan. 30, 2004.

(51) Int. Cl. H01J 17/16; H01J 61/30; H01J 61/35

(52) U.S. Cl. 313/634; 313/635; 313/573; 313/493

(57) ABSTRACT

A ceramic arctube preferably for a high pressure discharge lamp. The ceramic arctube can have an anti-reflection interference coating on the outside or inside surface of the bulb section of the arctube. The outside and/or inside surface of the outer wall of the bulb section of the arctube can be substantially spherical to increase efficiency. The wall thickness of the outer wall of the bulb section can be shaped to lens rays from the arc toward a preselected region of a reflector optically coupled to the arctube to increase efficiency.

This application claims the benefit of U.S. Provisional Application No. 60/540,475 filed Jan. 30, 2004, the contents of which are incorporated herein by reference.

### FIELD OF THE INVENTION

The present invention relates generally to ceramic arctubes used in lamps to generate light and more particularly to optical control of light from ceramic arctubes in high-pressure discharge lamps.

### BACKGROUND OF THE INVENTION

High pressure discharge lamps produce light by ionizing a fill material such as a mixture of mercury and halogen or metal halide with an electric arc passing between two electrodes. The electrodes and the fill material are sealed within a translucent or transparent arc chamber or discharge chamber in an arctube which contains and maintains the pressure of the energized fill material and allows the emitted light to pass through it. Historically, the arctubes were formed from quartz. However, ceramic arctubes have been developed to operate at higher temperatures and pressures for improved color temperatures, color renderings, and luminous efficiency, while reducing reactions with the fill material. See U.S. Pat. No. 5,866,982, the contents of which are incorporated herein by reference. However, the ceramic materials that are used have a higher index of refraction than quartz, and might also scatter the light significantly more than quartz . This leads to difficulties in controlling the light which strikes and passes through the ceramic arctube. There is a need for improved ceramic arctubes wherein the emitted light is more effectively and efficiently controlled in order to provide enhanced performance. The present invention is directed to this need. The present invention has particular applicability in what are know as short arc discharge lamps, where the arc gap is about, for example, 1 mm, and more generally in any lamp producing a well-controlled beam of light.

### SUMMARY OF THE INVENTION

There is provided a ceramic arctube to generate an arc for a discharge lamp, the arctube comprising a ceramic outer wall which has a bulb section. The arctube further comprises a fill material inside an arc chamber in the bulb section and further comprises a pair of electrodes. The ceramic arctube has one or more features for optical control of light selected from the group consisting of a) an anti-reflection interference coating on the outside or inside surface of the bulb section; b) the outside or inside surface of the outer wall of the bulb section being substantially spherical; and c) the wall thickness of the outer wall of the bulb section being shaped to lens rays from the arc toward a preselected region of a reflector optically coupled to the arctube.

### BRIEF DESCRIPTION OF THE DRAWINGS

FIG. 1 is a cross sectional view of a ceramic arctube according to the present invention.

FIG. 2 is a cross sectional view of an alternative embodiment of a ceramic arctube according to the present invention.

FIG. 3 is a cross sectional view of an alternative embodiment of a ceramic arctube according to the present invention.

FIG. 4 is a cross sectional view of an alternative embodiment of a ceramic arctube according to the present invention.

FIG. 5 is a cross sectional view of an alternative embodiment of a ceramic arctube according to the present invention.

FIG. 6 is a schematic cross sectional view of a reflector lamp comprising a ceramic arctube according to the present invention.

### DETAILED DESCRIPTION OF THE PREFERRED EMBODIMENTS OF THE INVENTION

As used herein, when a range such as 5-25 or 5 to 25 is given, this means preferably at least 5 and, separately and independently, preferably not more than 25.

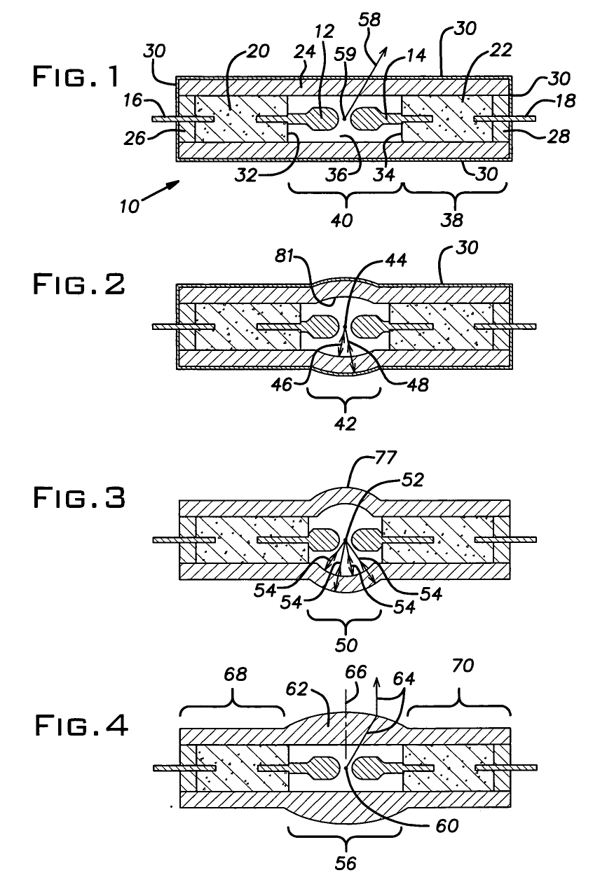

With reference to FIG. 1 there is shown in cross section a ceramic arctube 10 according to the present invention. The arctube 10 comprises electrodes 12, 14, outer leads 16,18, bodies of electrically conductive material 20, 22, a cylindrical ceramic outer shell or wall 24, and end plugs 26, 28. An anti-reflective (A/R) thin film interference coating 30 is shown disposed on the outer surface of the arctube 10. The ceramic outer shell 24 is cylindrically shaped around a longitudinal axis defined by the longitudinal axes of the outer leads 16,18 and the electrodes 12, 14 and outer shell 24 may have an outer diameter of 4-20, more preferably 6-10, mm.

The ceramic outer shell 24 is preferably poly-crystalline yttrium-aluminum-garnet (PC YAG)—Y₃Al₅O₁₂; less preferably single crystal YAG; less preferably sapphire (Al₂O₃); less preferably microcrystalline alumina (MCA); less preferably spinel (MgAl₂O₄) or AION (Al₂₃O₂₇N₅) or Yttrialox (Y₂O₃ and ZrO₂) or polycrystalline alumina (PCA). Ceramic outer shell 24 is preferably 0.3-3, more preferably 1-2, more preferably 1.5-1.6, mm thick.

The end plugs 26, 28 are preferably ceramic and preferably of the same ceramic material as outer shell 24 so their thermal expansion coefficients are matched. The thickness of the end plugs 26, 28 is the same as or comparable to the thickness of the outer shell 24. Alternatively the end plugs may not be included in the arctube. The outer leads 16, 18 are preferably molybdenum or niobium. The electrodes 12,14 are a refractory metal preferably tungsten. The bodies of electrically conductive material 20, 22 are preferably a cermet (ceramic metal composite) material as known in the art or alternatively a metallic conductor such as a molybdenum mandrel with an overwind (preferably molybdenum). The inside bulb length, which is from surface 32 to surface 34, is preferably 5-20, more preferably 6-15, more preferably 8-12, mm. The chamber 36 between surfaces 32 and 34 is also called the arc chamber or discharge chamber and contains a fill material as known in the art. The portions of arctube 10 distal to the arc chamber are the leg sections; leg section 38 is shown. Bulb section 40 is also shown.

One aspect of the invention is an anti-reflection (A/R) thin film interference coating 30 applied to the outside surface of the arctube 10 for the purpose of offsetting the undesirably high Fresnel reflections from the outer ceramic surface of the bulb section 40 due to the very high index of refraction of ceramic. Typically the index of refraction of the preferred ceramic materials is in the range of 1.7 to 1.9, whereas the index of refraction of quartz is 1.46 over the range of visible wavelengths. More specifically, the index of YAG is 1.84, and of PCA or sapphire is 1.77. At an index of 1.84, both the inside and outside surfaces of a YAG envelope or arc chamber will cause 8.7% of the light at normal incidence angles to be Fresnel reflected, whereas each surface of a quartz envelope will result in only 3.5% Fresnel reflection. Therefore, a ceramic envelope will typically result in approximately 5% greater Fresnel reflection per surface, or 10% greater Fresnel reflection from both surfaces of the envelope, relative to a traditional quartz envelope. Most Fresnel reflected rays cannot be easily collected into the useful light beam in demanding applications.

Typically the Fresnel-reflected light is returned specularly back generally toward the arc light source. If the light passes directly through the arc source, then the light will re-emerge from the arc source as potentially useful beam output light. However, any Fresnel-reflected light that misses the arc source (located at the reflector focal point) will probably be lost from the output beam, since it will have emanated from outside the focal point of the reflector. Therefore, a typical ceramic arctube which does not incorporate the present invention will provide as much as 10% less useful light in the beam.

An A/R coating applied to the outside or inside surface of the ceramic arctube is typically capable of eliminating about 65-90% of the Fresnel reflections, so the loss at each surface can be reduced by about 3-4 percentage points, thereby directly boosting the beam output by about 6-8%, if both surfaces are A/R coated. The A/R coating 30 can be disposed on the outer surfaces of the outer shell 24 and the end plugs 26, 28 as shown in FIG. 1. Alternatively the coating 30 can be disposed only on the outside circumference of the length of the shell 24 (not on the exposed ends which are perpendicular thereto), or only on the portion of outer wall 24 outside the arc chamber, i.e., on the outside surface of bulb section 40. Preferably all or substantially all of the outside and/or inside surfaces of the bulb section is coated with coating 30. If applied to the inside surface, the A/R coating need only be applied to the circumference of the length of the inside shell between surfaces 32 and 34. The A/R coating which is applied is an interference thin film coating using preferably tantala in alternating layers with silica. Alternatively, in place of tantala the following materials may be used: titania, niobia, alumina, mixed oxide solutions such as titania-tantala, or other materials known in the art. The A/R coating is preferably a conventional A/R coating, such as normally applied to glass or quartz substrates which have an index of refraction of 1.4-1.5, but the present A/R coating should be modified as is known in the art to accommodate the higher index of refraction of ceramic of 1.7-1.9, typically about 1.8.

The A/R coatings in the present invention can be applied using any number of common coating techniques as known in the art, most notably by chemical vapor deposition (CVD), physical vapor deposition (PVD), and evaporation methods. Many variations exist related to these general coating process families, including but not limited to, metal-organic CVD (MOCVD), plasma-enhanced CVD (PECVD), plasma-assisted CVD (PACVD), plasma-impulse CVD (PICVD), and atmospheric-pressure CVD (APCVD). A similarly large number of PVD variations exist as well, most of which use a sputtered material as the coating source. Common evaporation systems use for instance either electron beam to melt and cause evaporation of the coating material source, or ion-assisted evaporation. Masking techniques as known in the art can be used to provide an A/R coating only over the bulb section 40.

An example of an A/R coating on a ceramic YAG substrate is now given, using tantala and silica. Only one side was coated. Layer #1, which was immediately adjacent the substrate, was 160.13 nm silica. The other layers were: Layer 2 was 12.41 nm tantala; Layer 3 was 18.89 nm silica; Layer 4 was 101.45 nm tantala; Layer 5 was 82.37 nm silica. An uncoated YAG substrate has a photopic reflectance of about 17.4%. The entitlement associated with coating one side of the YAG substrate with a perfectly non-reflective coating would reduce the total reflectance down to about 8.7%. With the example 5-layer design, the expected reflectance is reduced to about 9.4%, which corresponds to a reduction in the total reflectance of about 41%, or about 91% of the entitlement. Other A/R coatings known in the art can be used on arctube 10.

In addition, the same or similar A/R coating can be applied to the inner surface of the ceramic arctube 10, preferably and for example to the inner surface of a ceramic arctube with a straight cylinder as shown in FIG. 1. If a CVD coating technique is used to coat the inside surface of the ceramic arctube, then the aspect ratio (length/inside diameter) should be preferably below 20, more preferably below 10 in order to provide the necessary control of thicknesses of the layers. If this coating were applied to both the inside and outside of the YAG substrate, then the total reflectance would be reduced to about 1.4%, which corresponds to a reduction in the total reflectance of 91%. Further, the A/R coating design can be modified as is known in the art to reduce reflection losses in the ultraviolet (UV). Containment of the UV inside the arctube can be advantageous in reducing exposure of the downstream optical components to UV in the light beam, and/or to further enhance the efficacy of the arc discharge. The A/R coating 30 preferably contains 2-100, more preferably 3-20, more preferably 3-7, layers.

With reference to FIG. 2 there is shown a ceramic arctube which is the same as arctube 10 except that the bulb section 42 has elliptical (or alternatively any concave curved) outer and inner surfaces as shown around a focal point 44 which is approximately midway between the electrodes. (As known in the art, the arc is located at the focal point, which is approximately midway between the electrodes and which is the focal point of the reflector.) For example, the outer and inner surfaces can be an arc of a circle having its center below or beyond focal point 44. The benefit is that, when compared to a straight cylindrical bulb section 40 as shown in FIG. 1, a greater proportion of the rays 46, 48 which reflect off the inner and outer surfaces of the bulb section 42 will pass back through the focal point 44 and thus be utilized as part of the useful controlled beam output. Also the A/R coating 30 can be applied. But, the advantage of the curved surfaces for directing Fresnel reflected rays back through the arc is even more useful for a ceramic arctube which does not have an A/R coating to reduce the Fresnel reflections.

With reference to FIG. 3 there is shown a ceramic arctube which is the same as the arctube of FIG. 2 except that, as shown, the bulb section 50 is spherically shaped with spherical or substantially spherical and concentric outside and inside surfaces (which appear circular when shown in cross section) with their centers at focal point 52; also the A/R coating 30 has not been shown for clarity although it can be applied. Thus FIG. 3 shows the outside and inside surfaces of the outer wall of the bulb section being spherical or substantially spherical. The advantage of the spherical surfaces for directing Fresnel reflected rays back through the arc is even more useful for a ceramic arctube which does not have an A/R coating to reduce the Fresnel reflections. The benefit is that many, or a substantial or material proportion, or most, or substantially all, of the rays 54 which reflect off the inner and outer surfaces of the bulb section 50 will pass back through the focal point 52 and thus be utilized as part of the useful controlled beam output. This design is far preferred to the design of FIG. 2, which in turn is preferred to the design of FIG. 1 because more of the light rays which reflect off the inner and outer surfaces of the bulb section pass back through the focal point and are utilized as part of the useful beam output. Less preferably the inner surface or the outer surface of the bulb section, but not both, can be spherically shaped with its center at the focal point 52.

The arctubes of FIGS. 2-6 can be without A/R coating 30, but preferably they have A/R coating 30 as described above.

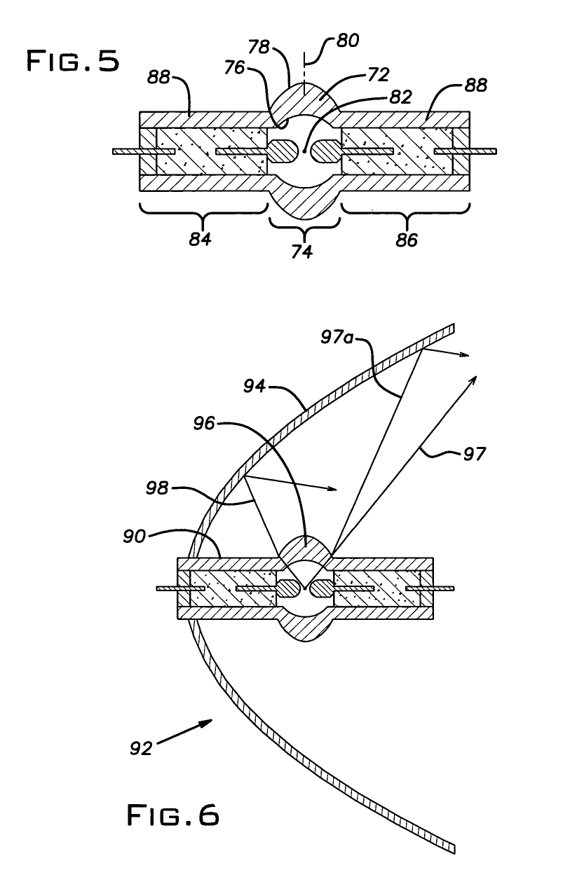

FIG. 4 shows a ceramic arctube which is the same as the arctube of FIG. 1 except that the A/R coating has been not shown for clarity and the bulb section 56 is thickened as shown to create a lens portion 62 which lenses the emitted rays. For example, FIG. 1 shows ray 58 originating at focal point 59 about midway between the electrodes and passing in a substantially straight path through the ceramic outer wall 24. However, in FIG. 4, ray 64 originates at focal point 60 and is lensed or bent as it passes through lens portion 62 of the ceramic outer wall. By altering the wall thickness and providing a lens portion 62, this causes lensing of the rays from the arc toward more favorable regions of the reflector (such as the central or middle portion of the reflector) in order to improve the overall light collected into the application. To achieve lensing of the rays, the shape of the ceramic outer wall is modified so that the curvature on the outside surface is greater than the curvature on the inside surface, acting like or being a convex lens, with the wall thickness being greatest at the equator 66 and gradually and smoothly getting thinner as you approach the leg sections 68, 70. Thus the desired lensing is achieved. As shown in FIG. 4, the inner surface of the bulb section 56 is cylindrically shaped around a longitudinal axis defined by the longitudinal axes of the electrodes.

FIG. 5 is the same as FIG. 4 except that lens portion 72 is achieved by providing a bulb section 74 which has a spherical inner surface 76 centered at focal point 82 and a parabolic, elliptical, or other curved outer surface 78. Thus the inner surface 76 of the bulb section 74 defines a non-cylindrical bulbous shape around a longitudinal axis defined by the longitudinal axes of the electrodes. As can be seen, a lens portion 72 is provided since the wall thickness decreases as you go from the equator 80 toward the leg sections. One benefit of this design is that light reflected off the spherical inner surface 76 is reflected back to the focal point 82 and thus utilized as useful beam output, while an AIR coating 30 can be provided on outer surface 78 so that reflections off the outer surface 78 are reduced or minimized. Alternatively lens portion 72 can be provided wherein outer surface 78 is substantially spherical with its center at focal point 82 (i.e., like outer surface 77 in FIG. 3) while inner surface 76 is (a) arced with a longer or substantially longer radius of curvature than the radius of curvature of outer surface 78 so that a lens shape is provided, or (b) elliptical or a shallow curve like inner surface 81 in FIG. 2. The result is to provide a lens which preferably has a smoothly curved outer surface and a flat or smoothly curved inner surface and which is thicker at the equator and gradually gets thinner as you approach the leg sections.

Where the leg sections 84 and 86 join or merge into bulb section 74, and thus where outer wall 88 merges into lens portion 72, preferably the wall thickness is maintained consistent or substantially constant so that there is a smooth transition from outer wall 88 into lens portion 72 and then lens portion 72 gradually gets thicker as shown. With regard to lens portions 62 and 72, the ratio of the thickness of the lens portion at the equator to the thickness of the lens portion where it merges into the leg section outer wall is preferably between 10 and 1.01, more preferably between 5 and 1.05, more preferably between 3 and 1.1, more preferably between 2.5 and 1.3, more preferably 2 or about 2.

With reference to FIG. 6, there is shown a reflector lamp 92 comprising a ceramic arctube 90 comparable to the arctube of FIG. 5, mounted in and optically coupled to a reflector 94 which, as known in the art, is preferably parabolic or elliptical. This shows the benefit of lens portion 96; if ray 97 was emitted without lensing, it would miss the reflector 94 and be lost as useful beam output. However, due to lens portion 96, ray 97a is bent or lensed so that it strikes the reflector 94 and is thus collected and utilized as useful beam output. Ray 98 is also lensed toward a more favorable region of the reflector 94.

The ceramic outer shell or wall 24 of FIG. 1 is preferably made via extrusion; the ceramic outer shell or wall (including the bulb section) of the arctubes of FIGS. 2-6 can be made via injection molding or slipcasting or other methods known in the art. If injection molded, it can optionally be made in two symmetrical pieces (separated along the equator 66 or 80) and then sintered together.

Another aspect of the invention is to provide a ceramic arctube with reduced bulk scattering from the bulb section. Light scattering in the bulk of a material can deflect light rays from their incident path. Scattered light rays can fall outside the focused light beam and reduce overall performance. Bulk scattering in sintered polycrystalline materials is caused by residual porosity, and by boundaries between grains, which typically have dimensions in the range 10 to 50 microns. In a vitreous material such as quartz or a single crystal ceramic, there are no grain boundaries and the density is 100% of theoretical so there are no internal voids. These materials have effectively zero bulk scattering. Bulk scattering in polycrystalline ceramic materials can be reduced by increasing density, thereby reducing porosity, and reducing internal voids, or by increasing the grain size to reduce the number of grains, or even by reducing the grain size to about 1 micron or less.

In order to reduce or minimize the amount of bulk scattering, the ceramic material is preferably sapphire (single-crystalline alumina Al₂O₃) or single-crystalline yttrium-aluminum-garnet (SC YAG)—Y₃Al₅O₁₂; less preferably poly-crystalline spinel (PC spinel)—MgAl₂O₄; less preferably poly-crystalline yttrium-aluminum-garnet (PC YAG)—Y₃Al₅O₁₂; less preferably poly-crystalline alumina (PCA)—Al₂O₃. In a preferred embodiment the outer wall of the bulb section is made of a single crystal.

The refractive indices “n”, resultant Fresnel reflections for two surfaces “R”, and light collection efficiency “e” of these materials in a typical application, accounting for both bulk scatter and Fresnel reflection losses, are:
1. Sapphire: n=1.77; R=15.4%; e=92%
2. SC YAG: n=1.84; R=17.5%; e=90%
3. PC Spinel: n=1.72; R=14.0%; e=90%
4. PC YAG: n=1.84; R=17.5%; e=85%
5. PCA: n=1.77; R=15.4%; e=55%

Preferably the present inventions are used in connection with lamps, preferably high pressure discharge lamps, preferably which have very short arc gaps and very precise control of beam pattern, having the following preferred characteristics. Lower and higher wattage lamps have parameters that scale from these values accordingly.
1. Fill material: mercury, halogen (preferably bromine, less preferably the other halogens), rare gas (preferably argon), and a small amount of oxygen. As known in the art, in the preferred short arc discharge lamp the fill does not include metal halide.
2. Mercury vapor pressure during operation: 2-600, more preferably 5-600, more preferably 50-600, more preferably 100-400, more preferably 200-300, more preferably 225-275, more preferably about 250, atm.
3. Amount of added mercury: 0.01-2, more preferably 0.05-1.5, more preferably 0.1-1, more preferably about 0.5, mg/mm³.
4. Distance (gap) between electrodes: 0.2-10, more preferably 0.2-5, more preferably 0.5-2, more preferably 0.7-1.3, more preferably about 1, mm.
5. Nominal voltage: 30-300, more preferably 60-120, more preferably about 75, volts.
6. Nominal wattage: 10-3000, more preferably 50-500, more preferably 100-300, more preferably about 300, W. The lamp typically provides 50-70 LPW.
7. Wall loading (based on inside surface area of arc chamber): 0.1-5, more preferably 1-3, more preferably about 2, W/mm².
8. Inside volume of arc chamber: 10-1000, more preferably 50-300, more preferably about 200, mm.
9. The diameter, shape and dimensions of the electrodes are as known in the art for quartz short arc lamps; see U.S. Pat. Nos. 5,357,167; 5,109,181 and 5,497,049, which are incorporated herein by reference. Preferably the shank diameter is 0.1-1, more preferably 0.3-0.5, more preferably about 0.5, mm; preferably the head diameter is 0.3-5, more preferably 1-2, more preferably about 2, mm.
10. If bromine is used in the fill, the amount of bromine which is added is preferably 10⁻¹² to 10⁻⁷, more preferably about 10⁻¹¹ to 10⁻⁹, moles/mm³. If the other halogens are used, the amount is similar.

A preferred use for the invention is for short arc ceramic arctubes in video projector lamps, also automotive, fiber optic, display, medical, scientific instrumentation, specialty and high intensity discharge lamp applications. Other commercial uses are for any lamp product using a ceramic, or high-index, arctube in an application demanding a well-controlled light beam (high brightness, low glare, etc.) The inventions can also be used in high temperature incandescent halogen lamps where the application desires a compact smaller envelope with a transparent ceramic arctube, and also compact electrodeless high intensity discharge lamps with a transparent ceramic arctube. The invention has applicability in all high pressure discharge lamps with ceramic arctubes, preferably high pressure mercury lamps, (which do not include metal halide), less preferably high pressure mercury-metal halide lamps (which contain mercury and metal halide) and high pressure metal halide lamps (which do not contain mercury in the fill) and also incandescent halogen lamps and electrodeless high intensity discharge lamps.

While the invention has been described with reference to preferred embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

1. A ceramic arctube to generate an arc for a discharge lamp, said arctube comprising a ceramic outer wall which has a bulb section, said arctube further comprising a fill material inside an arc chamber in said bulb section, said ceramic arctube having one or more features for optical control of light selected from the group consisting of
a) an anti-reflection interference coating on the outside or inside surface of said bulb section;
b) the outside or inside surface of the outer wall of the bulb section being substantially spherical; and
c) the wall thickness of the outer wall of the bulb section being shaped to lens rays from the arc toward a preselected region of a reflector optically coupled to said arctube.

2. The arctube of claim 1, wherein said arctube has an anti-reflection interference coating on the outside or inside surface of the bulb section.

3. The arctube of claim 2, wherein said arctube has said anti-reflection interference coating on substantially all of the outside surface of the bulb section.

4. The arctube of claim 1, wherein the outside or inside surface of the outer wall of the bulb section is substantially spherical.

5. The arctube of claim 4, wherein the outside surface of the outer wall of the bulb section is substantially spherical.

6. The arctube of claim 4, wherein the inside surface of the outer wall of the bulb section is substantially spherical.

7. The arctube of claim 5, wherein the inside surface of the outer wall of the bulb section is substantially spherical.

8. The arctube of claim 1, wherein the wall thickness of the outer wall of the bulb section is shaped to lens rays from the arc toward a preselected region of a reflector optically coupled to said arctube.

9. The arctube of claim 8, wherein the inner surface of the bulb section is cylindrically shaped around a longitudinal axis defined by the longitudinal axes of the electrodes.

10. The arctube of claim 8, wherein the inner surface of the bulb section defines a non-cylindrical bulbous shape around a longitudinal axis defined by the longitudinal axes of the electrodes.

11. The arctube of claim 8, wherein the outside surface of the outer wall of the bulb section is substantially spherical.

12. The arctube of claim 8, wherein the inside surface of the outer wall of the bulb section is substantially spherical.

13. The arctube of claim 12, wherein said arctube has said anti-reflection interference coating on substantially all of the outside surface of the bulb section.

14. The arctube of claim 1, wherein the outer wall of the bulb section is made of a single crystal.

15. The arctube of claim 1, wherein said arctube is disposed in a video projector lamp.

16. The arctube of claim 15, said arctube further comprising a pair of electrodes.

17. The arctube of claim 4, wherein the outer wall of the bulb section is made of a ceramic selected from the group consisting of sapphire, single-crystalline yttrium-aluminum-garnet and poly-crystalline yttrium-aluminum-garnet.
